(19) United States
(12) Patent Application Publication
(10) Pub. No.: US 2002/0080888 A1
(43) Pub. Date: Jun. 27, 2002

(54) Message splitting and spatially diversified message routing for increasing transmission assurance and data security over distributed networks

(76) Inventors: Li Shu, Billerica, MA (US); Dorothy C. Poppe, Medford, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/025,147

(22) Filed: Dec. 19, 2001

Related U.S. Application Data
(60) Provisional application No. 60/258,127, filed on Dec. 22, 2000.

(51) Int. Cl. H04L 27/20; H04L 27/12; H04L 27/04

(52) U.S. Cl. 375/295

(57) ABSTRACT

The invention features an apparatus and method for transmitting a file via a communications network. The apparatus includes a file processor that converts a file into N message segments. The file can be reassembled from a subset of any M of the message segments, where N and M are positive integers, N is greater than M, and M is greater than or equal to 1. The apparatus includes a message segment transmitter. The transmitter transmits at least M of the N message segments to a receiver for reassembly of the file after receiving M of the N message segments.

### CROSS-REFERENCE TO RELATED CASE

This claims the benefit of and priority to U.S. Provisional Patent Application Serial No. 60/258,127, filed Dec. 22, 2000, the entirety of which is incorporated herein by reference.

### TECHNICAL FIELD

The invention generally relates to electronic communications, and, more particularly, to data assurance and security in a network-based communications environment.

### BACKGROUND INFORMATION

Mobile ad-hoc networking (“MANET”) will likely be of growing importance in a variety of applications, such as mobile, computer-based collaborative work and military communications. Each unit, or node, in such a network may initiate or receive communications, or forward a communication, which may be, for example, a packet of information, between two other units in the network. Since the units may be mobile, a functioning MANET must accommodate variations in the communication pathway between any two units.

Perhaps the earliest and still best known example of a MANET can be found in the use of citizens band radios (commonly called CB radio). Such radios have a broadcast range limited to approximately 15 miles. Three or more mobile units, located, for example, in trucks or automobiles, can participate in the exchange of communications between two units when the two units are too distant from each other for direct radio contact. In this example, those individuals controlling the additional units may relay communications between the two units which are outside of each others'direct radio contact; and the packets of information might include a message and the identity of the intended recipient of the message.

Since, in a MANET, all units may generally be in constant motion, the neighboring nodes with which a node can communicate directly (called the node's immediate neighborhood) may change over time. The aggregate variation of all nodes' immediate neighborhood is sometimes called the variation in the network configuration. Such variations may cause the communication pathway between two particular units through the network to also vary with time.

Such a communication pathway, that is, the series of units involved in forwarding a communication, may change rapidly. Further, the quality of radio transmissions between any two adjacent units on such a communications pathway can degrade over time because of variations in, for example, the radio propagation environment and the mobility. These changes may occur during the transmission of a single packet of information.

As in any communications network, proper functioning of the MANET requires an effective message routing method or protocol. Moreover, an effective routing method employed in a MANET must, in addition, attempt to accommodate constantly varying communication links between individual mobile units. This requires maintaining accurate knowledge of the variations in the network's configuration. The only means of disseminating such information, however, is through the MANET itself. Hence, the amount of networking resources (e.g., communications bandwidth and mobile unit battery power) that a routing algorithm requires to function properly must also be considered in evaluating its effectiveness.

A number of routing methods have been proposed for use in MANETs in recent years. These largely employ broadcast routing of communications, where a message packet contains routing information to enable forwarding of the packet to the destination unit. Under this protocol, units forward messages using either a connectionless or connection-oriented approach. Both approaches require that each mobile unit participate in a background effort to maintain up-to-date information on network configuration and communication links, and a routing pathway is determined prior to transmission of a communication along the pathway.

As discussed earlier, one consequence of nodal movement is the change over time of the characteristics of the direct communication links between neighboring nodes. These constant variations in link characteristics and in network configurations represent two significant differences between MANETs and conventional networks, which are comprised mostly of stationary, point-to-point communication links. Thus, methods for improving or achieving certain levels of data assurance in MANETs will differ from those currently employed for conventional networks, and must be tailored to deal with these time-varying characteristics in link quality and message paths.

In the past, most developments in data networking have assumed fixed links between nodes. In such networks, the availability of such links is often very high, and characteristics of such links remain statistically stationary over time. Hence, these characteristics can be measured simply, and a two-pronged approach has been designed to maintain the desired level of data assurance.

Specifically, channel encoding methods are used to assure data delivery under the majority of channel conditions. When the channel conditions become sufficiently severe that the level of channel encoding cannot assure the delivery of the data, mechanisms are designed into the protocol to allow for re-transmission of the messages. The rarity of severe channel conditions is controlled by the choice of the channel encoding mechanism in the design. In addition, a retransmission mechanism may also respond to network congestion—which can be modeled—from the perspective of the two nodes at the two ends of a routing pathway, as channel conditions become sufficiently severe.

In conventional networks, the two-pronged approach is designed because traditional channel encoding techniques can be used to improve data assurance in communications, at a cost in both system complexity and bandwidth overhead. Beyond a certain point, increasing data assurance by choosing more protective channel encoding techniques to accommodate occasionally severe network conditions can incur costs that compare unfavorably to simply retransmitting data because the occurrences of such severe channel conditions may be sufficiently rare. Optimal utilization of a fixed-link network is typically achieved by balancing use of channel encoding techniques and retransmission.

In comparison, the characteristics of each link in a MANET are subject to variations in, e.g., the radio channels. The radio signal is subjected to signal strength variation and the Doppler effect caused by the relative mobility of either the transmitting node, the receiving node, or other structures acting as reflectors or obstructions in between. Additionally, the radio signal can be reflected from structures and vehicles and cause multi-path destructive interference, and can be blocked by structures and vehicles. These factors cause the link characteristics to vary more dramatically and over a much larger range than those in traditional fixed link networks. In general, these variations are no longer statistically stationary.

The two-pronged approach of encoding and retransmission can be applied to MANETs. Though sub-optimal, this approach can support communications when variations in link characteristics are sufficiently slow and/or small. In contrast, in cases when the variations in link characteristics are fairly large and rapid (such as MANETs in an urban environment, in the presence of dense foliage or in variable terrain), such adaptations of a two-pronged approach would not be able to capture these variations. Consequently, the application of the two-pronged approach to such cases would have to either rely un-necessarily heavily on the channel encoding techniques to compensate for the channel variations—which can significantly under-utilize the network resources—or heavily rely upon the retransmission mechanism.

Retransmission is inherently inefficient because it is costly in bandwidth usage and delivery delay. These costs are compounded in a MANET by the potential competition for link usage by multiple nodes in one node's immediate neighborhood. Such competition can be significantly more costly in MANET usage than in conventional network usage because the nodes competing for the same channel may not be aware of each other's existence (the so-called hidden terminal problem). This may result in excessive retransmission, which can degrade network performance more severely in MANETs than in conventional networks.

Additionally, existing data assurance methods typically do not provide security at either the information or the networking levels, and may even cause the degradation of security. Further, retransmission of an entire message generally compounds the information security risk. At the same time, applying channel coding to message bits and blocks does not provide any data assurance during failure of a route or path. Neither do existing methods of data encryption and authentication provide data assurance when data packets are lost due to interception or jamming.

Traditional methods of providing data security against eavesdropping (such as keyed encryption) grew out of point-to-point or single user communication channel models. The networking environment is, in general, underutilized for improvements in data assurance and security.

### SUMMARY OF THE INVENTION

The invention generally involves reliable and secure data transmission over a network. The invention is particularly suited to wireless ad hoc networks composed of mobile nodes, which has time-varying communication links between the nodes. In particular, when variations in the characteristics of the communication links between nodes are sufficiently large and rapid to permit useful tracking of the variations, the invention provides more robust and effective data delivery and delivery assurance than prior art methods.

Message assurance is accomplished in part by splitting a message into message segments that provide a suitable amount of redundancy (which can vary over time) for the message. Each such message segment is forwarded towards the destination node along, potentially, a different path. A receiver need only receive a fraction of the transmitted message segments to enable reconstruction of the original message. At the same time, the invention provides security gains that require little increase in system complexity or computational burden.

The fraction of segments required for message reconstruction can be dynamically adjusted to accommodate variations in the present condition of the network. Specifically, depending on the aggregate characteristics of the collection of network paths at a particular time, a selection protocol can dynamically select the most appropriate algorithms for processing a message into message segments. This is possible because sudden variations in the characteristics of an individual link may not significantly impact the aggregate characteristic of the collection of the paths. As the number of paths in the collection increases, the aggregate characteristics of the collection stabilize. Hence, tracking is possible.

By dynamically adjusting the fraction of message segments required for reconstruction, bandwidth utilization is optimized. The degree of redundancy in data transmission is reduced as network conditions improve, and increased as network conditions degrade. The invention eliminates any requirement to resend an entire message due to network transmission failures. As required, the amount of redundancy can be increased with a corresponding reduction in the fraction of message segments required for reconstruction of the message.

In particular, the invention provides reliable and secure transmission of messages in a MANET. Such a network is made up of mobile communication devices that are all peers. That is, no one device mediates communications for the network. Data assurance can be improved to arbitrary levels by choosing encoding and splitting schemes to tolerate a required level of segment transmission failures.

The invention can reduce message delay and increase utilization of each communication link in virtually any network, whether the nodes are mobile or fixed. The improvement in system resource utilization and performance can grow with the number of nodes and links in the network.

The invention also provides improvement of data security. Message segments are forwarded along different paths, and because multiple message segments are required to reconstruct the original message, an eavesdropper intercepting packets on a particular path can generally obtain little useful information. When message segments are forwarded along distinct paths to a destination, an eavesdropper must simultaneously intercept multiple message segments before a successful recovery of the original message becomes possible. The mobility of the nodes in the network makes this difficult. The number of message segments can be increased to further increase the difficulty of message interception.

Accordingly, in a first aspect, the invention features an apparatus for transmitting a file via a communications network. The apparatus includes a file processor that converts a file into N message segments. The file can be reassembled from a subset of any M of the message segments, where N and M are positive integers, N is greater than M, and M is greater than or equal to 1.

The file can be, for example, a computer data file, such as a binary data file. The processor can be, for example, a computer microprocessor integrated circuit.

The apparatus further includes a message segment transmitter. The transmitter transmits at least M of the N message segments to a receiver, which may reassemble the file after receiving M of the N message segments. The transmitter may be an integrated circuit that transmits the message segments via a network, such as an optical, electrical or wireless network.

The file processor may include a file encoder and an encoded file splitter that convert the file into the N message segments. The file encoder may implement a class of encoding algorithms in generating the message segments. The encoded file splitter may implement a class of splitting algorithms in generating the message segments.

The file processor and the file encoder may be implemented in software, firmware or hardware (e.g. as an application-specific integrated circuit). The software may be designed to run on general-purpose equipment or specialized processors dedicated to the functionality herein described. In the case of hardware implementation, the file processor and the file encoder may each be, for example, one or more integrated circuits. Alternatively, a single integrated circuit may include the file processor and the file encoder. One or more integrated circuits may implement file processing and file encoding software.

The file processor may include a network monitor that determines the condition of the communications network. The condition of the network may include many factors, and the network monitor may determine one or more of the factors. For example, in a wireless network, the condition may include information regarding the signal strength between nodes, which pairs of nodes are able to exchange communications, node movement, etc.

Based on the determined condition, a message segment parameter selector may select a set of values for M. The parameter selector may select a ration for M/N.

The parameters may be chosen to obtain a preselected probability of a successful transmission of M of the N transmitted message segments. For example, when the quality of the communication links degrades, the selected value for M/N may be decreased to provide more redundancy.

The file processor may associate, either explicitly or implicitly through methods such as embedding, N message segment identifiers with the N message segments, a one-to-one association existing between the N message segment identifiers and the N message segments. Each message segment identifier may be transmitted with its associated message segment. The identifiers may be, for example, alphanumeric labels. They may be used to identify message segments and assist reassembly of the message from the message segments.

In a second aspect, the invention features a method for transmitting a file. The method includes converting the file into N message segments that enable reassembly of the file from a subset of any M of the message segments. N and M are positive integers, N is greater than M, and M is greater than or equal to 1. The method further includes transmitting at least M of the N message segments to a receiver. The receiver reassembles the file after receiving at least M of the N message segments.

Transmitting may be accomplished by transmitting message segments via multiple pathways of a communications network. The network may be a wireless, electrical or optical network. The network may be an ad hoc network. The network may have mobile nodes. For example, the network may include a geographically distributed collection of radio transceivers.

Converting the file may include protecting the N message segments with a data security algorithm, or an algorithm that simultaneously provides data security and redundancy for this transmission scheme. Converting the file may include encoding the file and splitting the encoded file into the N message segments.

The encoding may include selecting one of a class of encoding algorithms by use of a selection protocol, and encoding the file in accordance with the selected encoding algorithm. Splitting the encoded file may include selecting one of a class of splitting algorithms by use of the selection protocol, and splitting the encoded file in accordance with the selected splitting algorithm.

Transmitting may include identifying the selected encoding algorithms for a receiver of the file through either explicit or implicit means. Encoding may further include selecting one of a class of encoding algorithms that provide for the recovery of the original data in the absence of some of the message segments.

An encoding algorithm may inject redundancy into the message segments, e.g., via use of erasure correcting codes, to enable reassembly of the original message without requiring the successful delivery of all message segments through their individual paths.

The method may also include receiving at least M of the N message segments and reassembling the file from as few as M of the N message segments. Reassembling the file may further include combining M of the N message segments and recovering the original message from the assembled message segments.

Converting the file may include associating the received message segments according to their unique identifiers. In another embodiment, converting the file includes analyzing the communications network to determine a condition of the communications network. Values for the parameters M and N are selected based on the determined condition to achieve a preselected probability of a successful transmission of M of the transmitted message segments.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an embodiment of a communication of a message from a source to a destination.

FIG. 2 illustrates an embodiment of a communication of a message that provides improved message security.

FIG. 3 illustrates an embodiment of a method that provides message delivery assurance and security.

FIG. 4 illustrates an embodiment of spatial diversification of message transmission, which transmits split message segments along three paths through a network.

FIG. 5 illustrates an embodiment of reassembly of a message at a destination.

FIG. 6 illustrates an embodiment where obstruction of a single node does not deny message transmission.

FIG. 7 illustrates an embodiment where eavesdropping on a single link provides no information.

FIG. 8 illustrates an embodiment with integration of data encryption into an encoder and a decoder.

FIG. 9 illustrates an embodiment with integration of data encryption into the splitter and the assembler.

FIG. 10 illustrates an embodiment of an apparatus for transmitting a file via a communications network.

### DESCRIPTION

The terms “file”, “message”, “data” and “data file” are herein understood to refer to any entity of data that may be transferred via analog or digital means. The entity may originate in analog or digital form, and, at various times, may be stored in analog or digital form. The entity is capable of transfer between two distinct physical locations via, in particular, electronic, wireless and optically based communications, for example, network-based communications.

An apparatus and method for data assurance in communication networks, preferably MANETs, makes advantageous use of features of networked communications. During a typical communications session (between, e.g., an originating node and a destination node), messages can be forwarded along multiple, variable data paths. Aggregation of a number of such paths forms a single “super path.” In one embodiment, a method includes encoding a message, splitting the encoded result into distinct message segments, and sending each segment along a different path. A receiving node may reconstruct the original message without the requirement that all message segments eventually reach the receiving node after traveling along their individual paths.

One embodiment includes a protocol that enables a sender to provide information to a destination, i.e., receiver node, about encoding and splitting algorithms that were used to process a message. Some embodiments include methods for inferring the status of the collection of links. Some embodiments include one or more algorithms for determining which combination of encoding and splitting algorithms to use in response to a current status of the links.

Hence, some embodiments enable dynamic adjustment in response to changing network communication conditions. One such embodiment includes a set of encoding/decoding algorithms and a set of splitting/reassembling algorithms to permit an optimized response to the dynamic variations in the link characteristics. Modified algorithms can incorporate data security enhancement features.

For example, encoding algorithms may be used to prevent the deduction of any part of the original message from individual processed message segments. A minimum number of message segments may be required to reconstruct the original message. Further, encryption keys may be used to enhance security. In particular, security enhancement can be achieved by deterministically varying a set of splitting/reassembling algorithms.

Data assurance in MANETs can be adjusted to a desired level by choosing an appropriate encoding and splitting scheme to tolerate failures over a sufficiently large number of paths. Encoding redundancy can reduce or eliminate the need for message retransmission. Message delay may be reduced, and utilization of each link in the network may be increased. Generally, the benefit in overall network resource utilization and performance grows with the number of links, i.e., the number of directly communicating node-pair combinations, and the expected number of relaying hops through which a packet is forwarded towards its destination.

In one aspect, the apparatus and method improve data security. As multiple message segments are required to decode the original message, an eavesdropper sniffing, e.g., packets traveling on a particular path cannot deduce much useful information. Additional security components or steps can improve the level of data security; for example, encoding mechanisms can be chosen to avoid exposing the original data bits directly and a bit-position scrambling mechanism can be incorporated before splitting of the message. This provides security gains that require almost no increase in system complexity or computational burden.

In one embodiment, a redundantly encoded message is transmitted by aggregating multiple paths in a MANET to form a single super-path. This aggregation provides robustness in view of the potentially drastic variation in individual links. The super-path has a collective characteristic that improves stability, and statistically resembles a fixed link pathway in comparison to a pathway through a conventional MANET.

The channel coding technique may first encode the message to inject the desired level of redundancy into the message, then split the encoded message into multiple segments, and then forward each segment along a different path. At the receiving end, the extra redundancy injected by the encoding method (via, e.g., erasure correcting codes) may permit reassembly of the original message without requiring the successful delivery of all message segments through their individual paths.

Encoding methods may be used to improve the data assurance to a desired level for a MANET. This is more effective for MANET-based communications than simply adopting or adapting the two-pronged approach of fixed point-to-point channels (and conventional networks). The characteristics of the aggregated super-path more closely resemble that of the fixed point-to-point channel than that of the individual member paths in the aggregate. Moreover, the variation in the characteristics of the super-path is slower than the variation of individual member paths, and can be designed to become tractable.

As a result, the variation of super-path characteristics can become more sensitive to network communications congestion than to link-to-link communication variations, e.g., radio frequency channel variations, arising from movement of the nodes. Hence, in one embodiment, super-path characteristics are regularly or continuously analyzed, and encoding and splitting algorithms are selected from classes of encoding algorithms and splitting algorithms in response to a determined characteristic. Super-path characteristics may include, for example, the number of successfully received message segments and the identity of the paths through which message segments are successfully received.

The performance of these classes of algorithms can be rated. Protocols that implement measurement of super-path characteristics and dynamic selection of an optimum combination of encoding algorithms and splitting algorithms can also be rated. Rating of algorithms and protocols can permit improved optimization of selections.

Encoding and splitting of messages directly improves message security. Because the message segments are forwarded along distinct routes to the destination, an eavesdropper must simultaneously intercept multiple message segments before a successful recovery of the original message becomes possible. The mobility and the geographical distribution of the nodes in the network make this difficult, and splitting the message into more segments can increase the difficulty of recovery. Furthermore, an encoding algorithm can be chosen that prevents message reconstruction without interception of at least a threshold portion of message segments.

Additional security is made possible by scrambling, even simple scrambling, of the positions of the encoded message bits, e.g. before splitting, to prevent message reconstruction by an eavesdropper even when the eavesdropper intercepts a sufficiently large number of message segments. Generally, scrambling and de-scrambling of bit positions requires many fewer operations to execute and complete than traditional encryption and decryption methods.

Some embodiments include a stand-alone protocol layer for insertion in the networking protocol layer. For example, the protocol layer can be inserted between the medium access control (MAC) layer and the networking layer of a communication system. The protocol layer may include mechanisms for monitoring or analyzing the characteristics of network links and a decision algorithm to dynamically choose one of a class of encoding and splitting algorithms based on the observed network link characteristics.

In one embodiment, when the link stability is low, the protocol layer switches to an encoding algorithm that tolerates more losses of the message segments and a message-splitting scheme that results in smaller segments, in an attempt to improve delivery assurance. In another embodiment, when the link stability improves, the protocol layer switches to an encoding algorithm that has requires more message segments to be received and a message-splitting scheme that uses larger segments, in an attempt to reduce the protocol overhead.

The impact of the proposed algorithm and the dynamic protocol can be measured at multiple levels of the network. The probability of delivery success in a single attempt can be improved to any desired level by choosing an appropriate combination of encoding and splitting methods or algorithms. Generally, an entire message is not transmitted along a single path. Instead, a message is fragmented, i.e. split, and forwarded along multiple paths. The realized increase in data assurance general comes with an initial delay in transmission of message segments, or packets, due to the encoding and splitting. Generally, however, overall communications delays are improved because of the improved probability of completion of each message transmission in the first attempt.

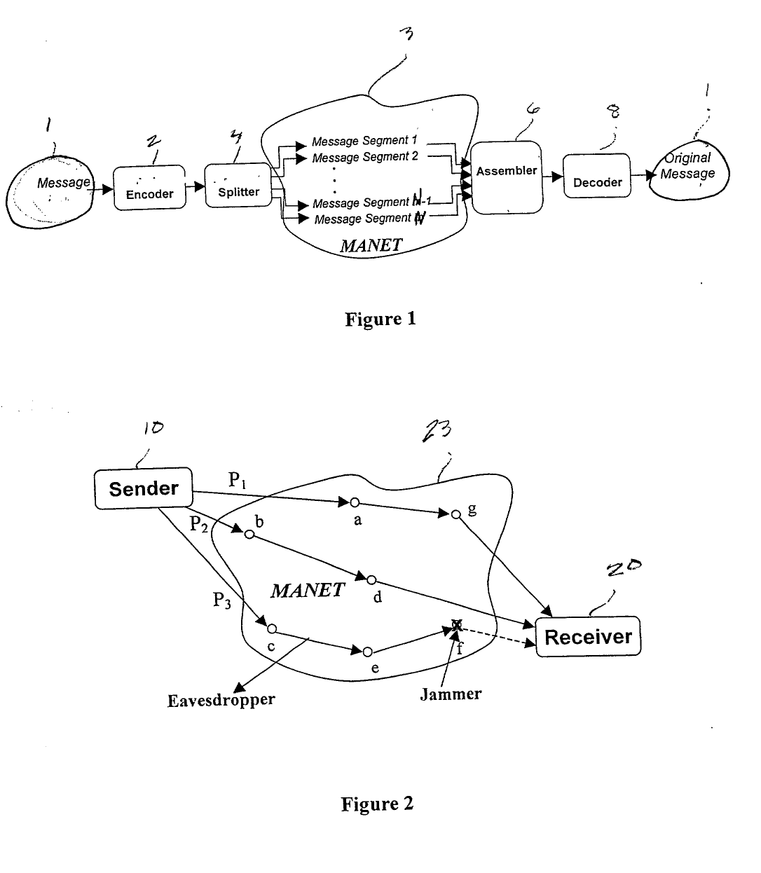

Referring to FIG. 1, an embodiment of a communication of a message from a source to a destination is illustrated. A message 1, e.g., a block of message bits, is fed to an encoder 2, e.g. a scrambling encoder. The encoder 2 injects redundancy into the message bit stream, which increases the number of bits in the message. The encoded message is fed to a message splitter 4, which breaks the message into N message segments.

The N message segments are forwarded to the destination along different paths in a MANET 3. An assembler 6 reassembles the encoded message as the segments are received. When the number of segments received reaches a specified threshold, a partially reassembled message is passed to a decoder 8, e.g. an erasure decoder. The decoder recovers the original message 1, using only the bits available from the partially assembled message. The threshold number of segments is determined by the selected coding scheme. Both the assembler 6 and the erasure decoder 8 may be implemented in hardware and/or as software modules.

Improving the probability of completed delivery of a message in a first attempt reduces both the average delay and the number of retransmissions required for deliver of messages through the network. Reducing the number of retransmissions decreases the number of channel contentions in a network with multi-accessing nodes such as a MANET. This may significantly improve the utilization of both the links and the network, in terms of factors such as the number of data bits sent per usage of bandwidth, channel, link, battery power, etc. This in turn significantly improves the overall network throughput and efficiency.

FIG. 2 illustrates an embodiment that provides improved message security. A sender 10 and a receiver 20 agree to use a combination of an encoding scheme and a splitting mechanism that splits each message into three segments for transmission via a MANET 23. The MANET 23 includes several nodes a-g. The encoding scheme requires at least two message segments to reach the receiver for recovery of a split message. An eavesdropper is illustrated as intercepting message segments between nodes c and e; a jammer is illustrated as blocking transmission of message segments at node f. Three paths P₁, P₂, P₃ through the MANET 23 are a subset of all possible paths. Message security and integrity are maintained in spite of the efforts of the eavesdropper and the jammer.

The eavesdropper acquires only a message segment transmitted along path P₃. Because the number of message segments threshold is 2, the single segment does not provide any useful information to the eavesdropper. All three segments will reach the receiver 20. The first two to arrive are used to reassemble the original message.

The jammer attacking node f prevents the message segment traveling on path P₃ from reaching the receiver 20. The other two message segments, however, arrive, and the message is recovered. The jammer cannot prevent the receiver 20 from getting the message.

Several criteria may be used to assess the performance of alternative implementations of a decision algorithm and a dynamic protocol. Such criteria may include, for example:

delivery assurance, the probability of successful receipt of a fully correct message (affected by the probability of link/node failure);

security improvement, in terms of the number of message segments that must be acquired by an eavesdropper in order to reconstruct the original message; and

improvement in effective bandwidth, the reduction in the number of required retransmissions as compared to, for example, the adaptation of the two-pronged approach to a MANET.

In one embodiment, a protocol is inserted into a network communications protocol stack, e.g., between the MAC and the networking layer. This protocol mechanism senses and predicts variations in the characteristics of the link aggregate, and dynamically chooses the best combination of encoding/decoding and splitting/reassembly algorithms from a set or class of algorithms. The attempt to optimize can seek a combination that adds the least overhead to achieve a specified probability of successful message delivery. The selection process may further include, e.g., consideration of message priority, other measures of message importance, or cost of latency.

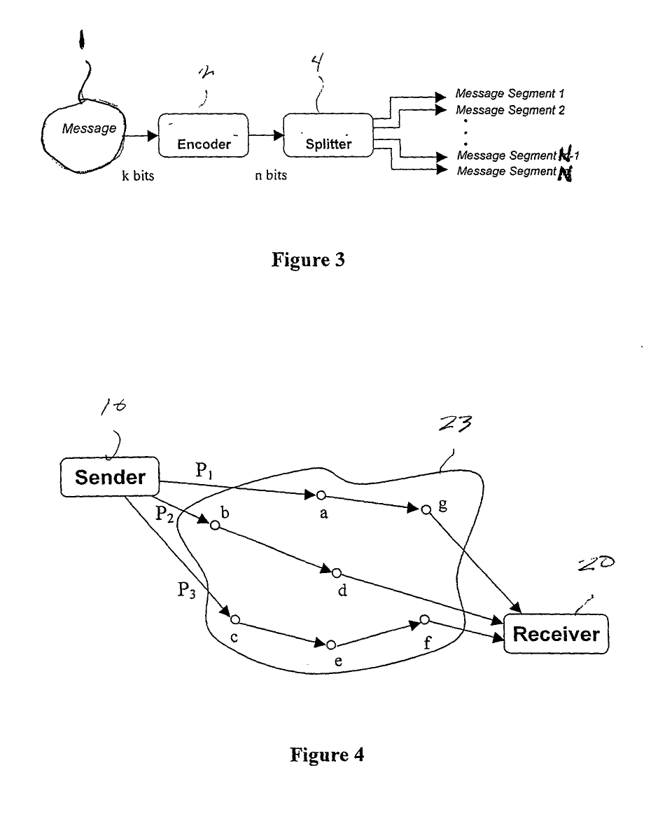

Referring to FIG. 3, one embodiment is illustrated of a method that provides message delivery assurance and security. The method includes encoding the message to inject redundancy into a message stream, and splitting the encoded message. The split, encoded message is forwarded along spatially diversified routes.

For example, a message, or message block, that includes k bits is processed through an encoder 2, e.g., a scrambling encoder, that converts the message into an encoded message block of n bits, where n>k. A splitter 4 decomposes the output of the encoder 2 into N message segments, each segment including no more than [n/N] bits. “[n/N]” denotes the least integer greater than n/N. N, n and k are positive integers.

FIG. 4 illustrates spatial diversification. Each of the N message segments is forwarded to the intended recipient, preferably along a different route. This gives spatial diversification to the routes used for transmission. Nodes a-g are a subset of MANET 23 nodes. The sender 10 forwards segments to the receiver 20 along path P₁ (including nodes a and g), path P₂ (including nodes b and d), and path P₃ (nodes c, e, and f). The different physical locations of the nodes forces the message segments to travel through different areas of the network. Link conditions and congestion in different areas may vary considerably.

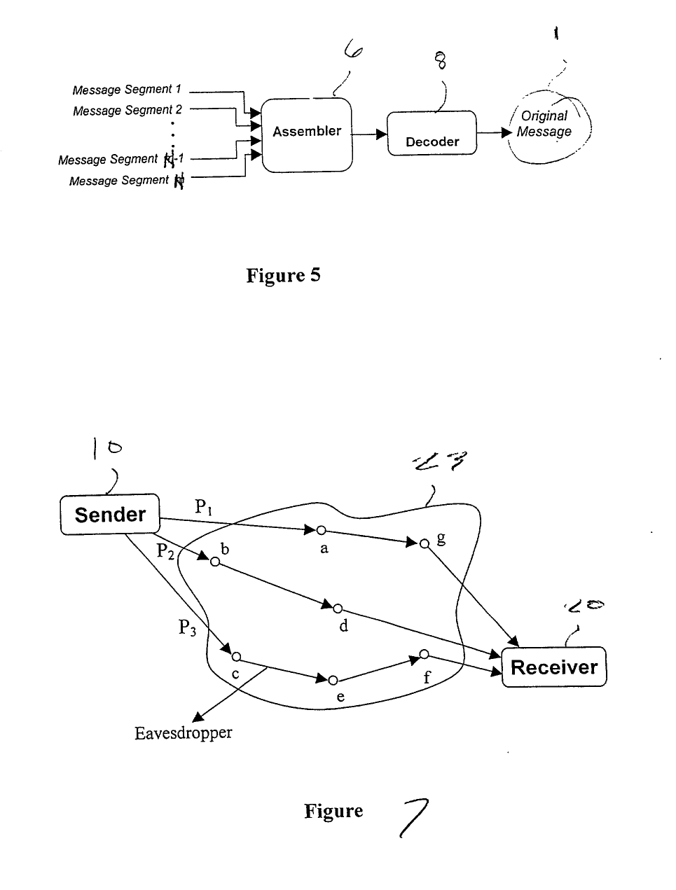

Referring to FIG. 5, the message segments are re-assembled as they are received at the receiver 20. When a sufficiently large number of message segments is received, the partially assembled message is forwarded to a decoder 8, e.g., an erasure decoder, which recovers the entire original message. Improved delivery assurance is achieved because not all message segments must be successfully received to permit the recipient to recover the original message.

In one embodiment, each message segment has a length of b, where 0<b ≦[n/N]. “[n/N]” denotes the least integer greater than n/N. Limitation of the value of b can assure that each encoded message bit exists in only one message segment. Because n must be greater than k, [k/b]<N. Hence, there are fewer than N segments when the shorter unencoded message is broken into segments of length b. A longer, encoded message is obtained with N segments of length b.

The intended recipient can recover the original message with any subset of [k/b] segments of the N message segments, given an appropriate selection of the encoding scheme. Hence, the message recovery mechanism at the intended recipient can tolerate the loss of some of the message segments. This allows for losses due to, e.g., network congestion, broken links, interference or jamming. This may require n bits to be transmitted for every k message bits, where n>k. Advantages are realized, however, such as:

n/k may be smaller than the number of bits that would be transmitted for each bit if an entire block is retransmitted; and

the probability that the intended recipient correctly recovers the original message from a single transmission attempt is improved.

Examples of classes of error-correcting codes that can be utilized include Bose-Chaudhuri-Hocquenghem (BCH) codes, Convolutional codes, Hamming codes, Reed-Solomon codes, Golay codes, Turbo codes, and several other linear and nonlinear block codes.

Various embodiments provide significant security benefits. Referring to FIG. 6, resistance to localized jamming is one benefit. Jamming, for example, disrupting transmission at a single network node or link, minimally impacts the functionality of the rest of the network. When a jammer located near node f has broken the continuity of path P₃, path P₁ and path P₂ are still able to deliver message segments, and the message is successfully decoded. To be effective at disruption, a jammer must be located close enough to either the sender 10 or receiver 20 to jam a significant number of message segments. For example, the probability of disruption in a mobile, military network is reduced by the requirement for close proximity of a hostile jammer.

Referring to FIG. 7, another security benefit of some embodiments is the difficulty an eavesdropper experiences when trying to intercept messages. As illustrated in FIG. 7, an eavesdropper is physically located between node c and node e, able to copy any message segment, e.g., data packet, that passes along path P₃. The eavesdropper must correctly receive a minimum of [k/b] message segments to recover a complete message. To receive the minimum number of segments, however, requires eavesdropping on other paths P₁, P₂.

Some embodiments prevent even partial message recovery by the eavesdropper. An appropriately chosen scrambling encoder (e.g., a non-systematic code) can be used to create a condition during which any subset of q message segments, with q<[k/b], will prove insufficient to recover any subset of the original message. Similar to the jammer, the eavesdropper must be physically located very close to either the sender 10 or the intended recipient 20 to effectively intercept segments from multiple paths P₁, P₂, P₃.

The effectiveness of a local jammer is reduced by taking advantage of the nature of a distributed networking environment. Similarly, a single eavesdropper has a reduced ability to observe enough segments to allow an understanding of the communications carried by the network. As a result, the overall security of information carried by the entire network is significantly improved.

Some embodiments further improve security through use of data encryption by means of bit position scrambling. The selection of a scrambling encoder can be controlled with an encryption key. In some alternative embodiments, the actual bit scrambling can be accomplished in either an encoder or a splitter.

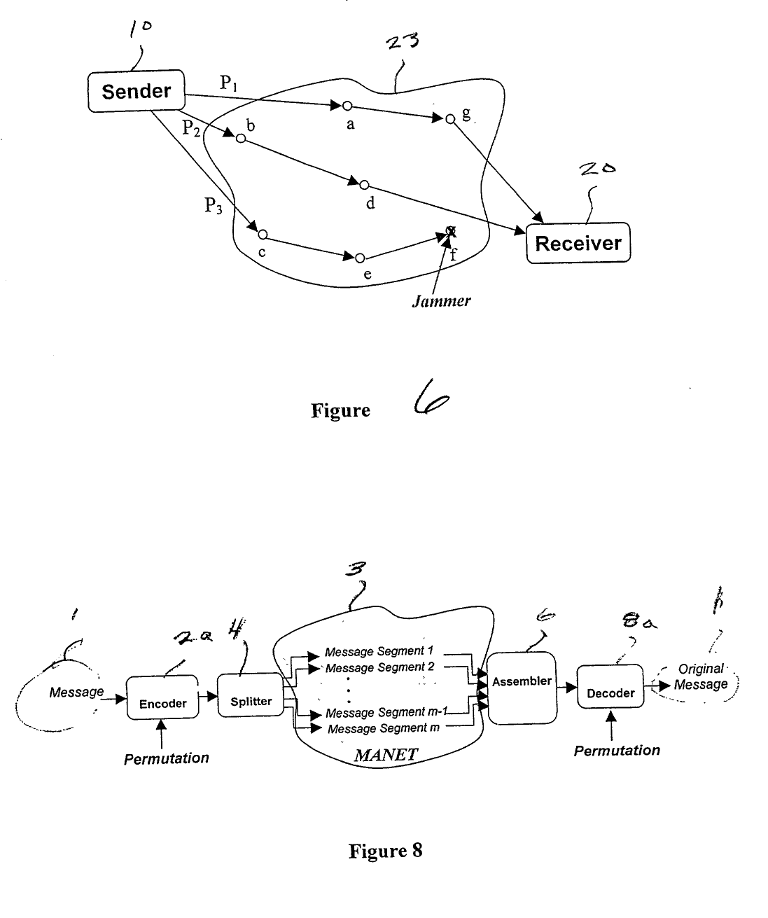

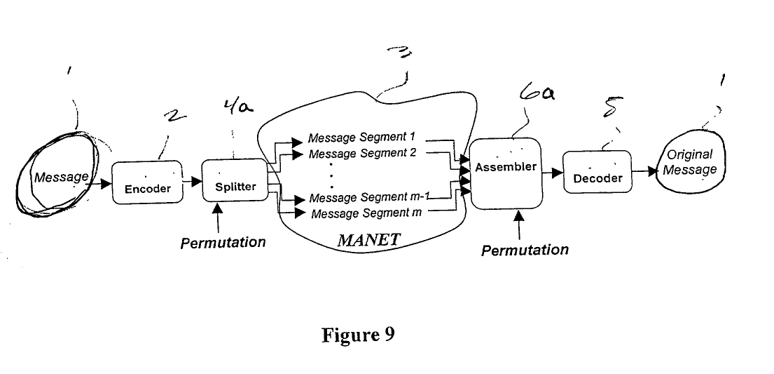

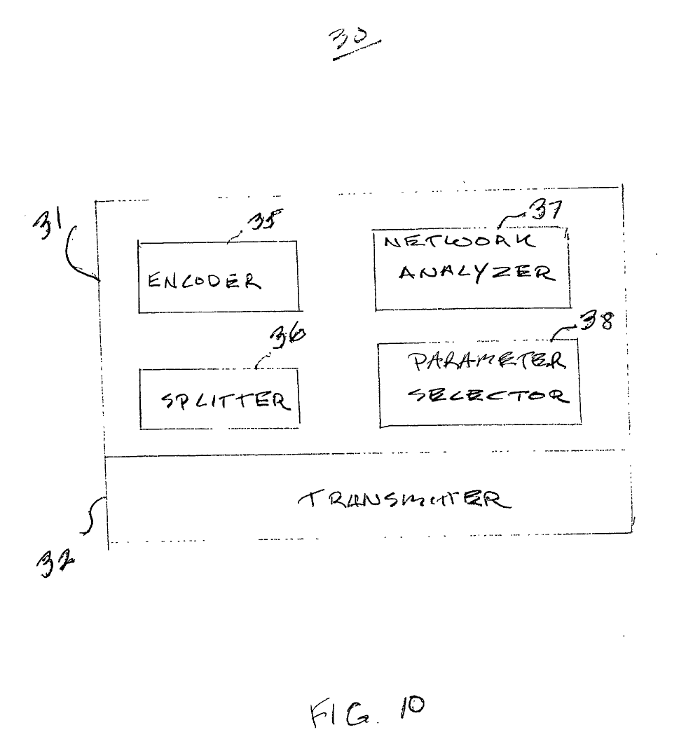

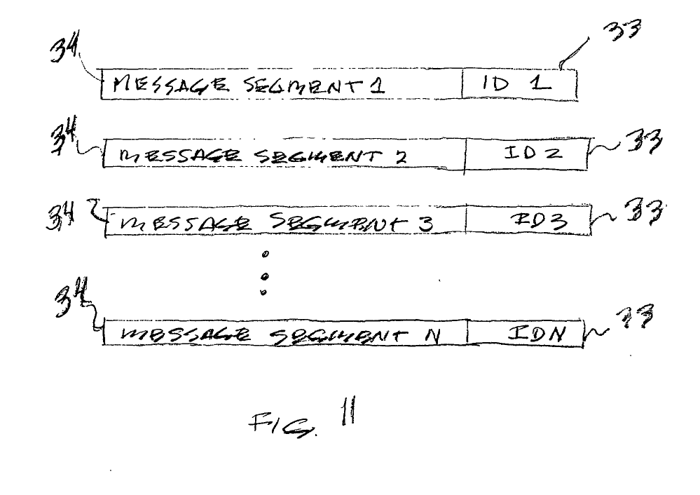

Referring to FIGS. 8 and 9, embodiments that utilize permutation are illustrated. FIG. 8 schematically shows the use of permutation by an encoder 2a. FIG. 9 shows the use of permutation by a splitter 4a. For example, even a simple use of an encryption key to alter bit positions in the encoded message, would require the eavesdropper to potentially search through n! possibilities.

Some embodiments that include a scrambling encoder employ an encoding scheme that provides one or both of the following features:

the encoding scheme provides strong resilience against loss of message segments, preferably having the value of (k+e) as close to n as possible, where e is the number of message segment losses that the scheme can overcome, k is the original message length, and n is the encoded message length; and

no bits in the original message are ascertainable from any message subset below a threshold number; for linear block codes, this generally requires use of non-systematic codes and that approximately half of the elements of a generating matrix elements have a value of 1.

In order for the assembler at the receiving node to correctly reassemble the message fragments, the content of each segment must be identified. In one embodiment, the information required for reassembly is reduced by inclusion of a numbering scheme for the message segments. In a preferred embodiment, a segment carries identification that is a number assigned by the message splitter. This number may be a field in a protocol header that is attached to each message segment, or embedded in the message segment itself.

Additional protocol header fields may be included when encoding and splitting algorithms are altered dynamically to better suit the observed characteristic variations of the super-path. The additional fields can carry measurement data regarding the characteristics of the super-path as well as data that informs the destination node of the changes in the encoding and splitting algorithms. Inclusion of additional protocol header fields incurs additional transmission bandwidth for every hop. Hence, it is preferable to optimize choices of fields to minimize the resulting bandwidth expansion.

Referring to FIG. 10, an embodiment of an apparatus 30 for transmitting a file via a communications network is illustrated. The apparatus 30 includes a file processor 31, which may be implemented in hardware and/or as a software module, and a message segment transmitter 32. The file processor converts files into N message segments that enable reassembly of the file from a subset of any M of the message segments. N and M are positive integers and N>M≧1.

The message segment transmitter 32, which may be implemented in hardware and/or as a software module, transmits message segments to a receiver. The receiver can reassemble a file after receiving M of the N message segments.

The file processor 31 may comprise a file encoder 35 and an encoded file splitter 36 that convert a file into N message segments. The file encoder 35 may implement a class of encoding algorithms in generating the message segments. The encoded file splitter 36 may implement a class of splitting algorithms.

The processor 31 may further comprise a communications network analyzer 37, which may be implemented in hardware and/or as a software module, that determines the condition of a communications network. The processor 31 may also include a message segment parameter selector 38 (which also may be implemented in hardware and/or as a software module) that selects a set of values for M and N based on the determined condition to achieve a preselected probability of a successful transmission of M of the transmitted message segments.

Referring to FIG. 11, the apparatus may include N message segment identifiers 33 that have a one-to-one association with the N message segments 34. In the embodiment illustrated in FIG. 11, message segments 34 are transmitted with their associated identifiers 33 to assist in reassembly of the message. The identifiers 33 can include, for example alphanumeric data. In one embodiment, during transmission, the identifiers 33 are binary numbers.

Some embodiments include two or more stages of file splitting. In these embodiments, one or more message segments from a first file splitting step may be further split into additional message segments. A second splitting step may be advantageous, for example, when a node that transmits files via a network has limited access to the network. For example, a node that transmits files via the Internet may have limited gateway access. The access may be limited, for example, to as few as one or two gateways.

The node might then split a file into a few message segments, for example three message segments, and transmit the message segments to the gateways. The gateways could further split one or more of the three message segments, and then forward message segments toward a receiver via the Internet.

In some embodiments of a method for transmitting a file, which include multiple splitting steps, the file is converted into N message segments that enable reassembly of the file from a subset of any M of the message segments. At least M of the N message segments are transmitted toward a receiver for reassembly of the file after receiving M of the N message segments.

At least one of the transmitted segments is further converted into N₂ message segments that enable reassembly of the at least one message segment from a subset of any M₂ Of the N₂ message segments, where N₂ and M₂ are positive integers and N₂>M₂≧1. At least M₂ of the N₂ message segments are transmitted toward the receiver for reassembly of the at least one message segment prior to reassembly of the file.

The at least M₂ segments may be reassembled by the receiver. Alternatively, the at least M₂ segments may be received and reassembled by an intermediate node. The reassembled segment may then be transmitted toward the final receiver. Additional conversion steps and/or reassembly steps may be included at intermediate nodes in a transmission network.

The above described and various other embodiments are of particular value when applied, for example, to ad-hoc networks, MANETs and conventional packet networks with distributed routing algorithms. Particular value accrues when applied to MANETs that include moderately mobile units.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An apparatus for transmitting a file via a communications network, comprising:
a file processor that converts the file into N message segments that enable reassembly of the file from a subset of any M of the message segments, where N and M are positive integers, and
N>M≧1;
and
a message segment transmitter that transmits at least M of the N message segments toward a receiver for reassembly of the file after receiving M of the N message segments.

2. The apparatus of claim 1 wherein the file processor comprises a file encoder and an encoded file splitter, which cooperate to convert the file into the N message segments.

3. The apparatus of claim 2 wherein the file encoder implements a class of encoding algorithms in generating the message segments.

4. The apparatus of claim 2 wherein the encoded file splitter implements a class of splitting algorithms in generating the message segments.

5. The apparatus of claim 2 wherein the file processor further comprises a communications network analyzer that determines a condition of the communications network, and a message segment parameter selector that selects a value for M and a value for N based on the determined condition to achieve a preselected probability of a successful transmission of M of the transmitted message segments.

6. The apparatus of claim 1 further comprising a communications network condition assessor.

7. The apparatus of claim 1 wherein the file processor associates N message segment identifiers with the N message segments, a one-to-one association existing between the N message segment identifiers and the N message segments.

8. A method for transmitting a file, comprising the steps of:
converting the file into N message segments that enable reassembly of the file from a subset of any M of the message segments, where N and M are positive integers, and
N>M≧1;
and
transmitting at least M of the N message segments toward a receiver for reassembly of the file after receiving M of the N message segments.

9. The method of claim 8 wherein the step of transmitting comprises transmitting message segments via multiple pathways of a communications network.

10. The method of claim 9 wherein the step of transmitting further transmits message segments via multiple pathways of an ad hoc network.

11. The method of claim 9 wherein the step of transmitting further transmits message segments via multiple pathways of a mobile ad hoc network.

12. The method of claim 8 wherein the step of converting the file comprises protecting the N message segments with a data security algorithm.

13. The method of claim 8 wherein the step of converting the file comprises the steps of encoding the file and splitting the encoded file into the N message segments.

14. The method of claim 13 wherein the step of encoding comprises the steps of selecting one of a class of encoding algorithms by use of a selection protocol and encoding the file in accordance with the selected encoding algorithm.

15. The method of claim 14 wherein the step of splitting the encoded file comprises the steps of selecting one of a class of splitting algorithms by use of the selection protocol and splitting the encoded file in accordance with the selected splitting algorithm.

16. The method of claim 14 wherein the step of transmitting comprises identifying the selected encoding algorithms for a receiver.

17. The method of claim 14 wherein the step of selecting one of the class of encoding algorithms comprises selecting an encoding algorithm that injects redundancy into the message segments to enable reassembly of the file by the receiver if less than N of the message segments are received.

18. The method of claim 8 wherein the step of converting the file comprises the step of associating the N message segments in one-to-one correspondence with N unique identifiers.

19. The method of claim 8 further comprising the steps of receiving at least M of the N message segments and reassembling the file from as few as M of the N message segments.

20. The method of claim 19 wherein the step of reassembling the file further comprises the steps of combining M of the N message segments and decoding the combined message segments.

21. The method of claim 8 wherein the step of converting the file further comprises the steps of analyzing the communications network to determine a condition of the communications network, and selecting a value for M and a value for N based on the determined condition to achieve a preselected probability of a successful transmission of M of the transmitted message segments.

22. The method of claim 8 wherein the step of converting the file comprises converting the file into N message segments that require an eavesdropper to intercept at least M of the message segments to reassemble the file.

23. The method of claim 8 wherein the step of transmitting comprises transmitting less than M of the N message segments on any one pathway of a plurality of pathways to inhibit an eavesdropper from recovery of the file.

24. The method of claim 8 wherein the step of transmitting comprises transmitting at most (N−M) of the N message segments on any one pathway of a plurality of pathways to inhibit a jammer from preventing reassembly of the file by the receiver.

25. The method of claim 8 further comprising the step of causing conversion of at least one of the M message segments into N₂ message segments that enable reassembly of the at least one message segment from a subset of any M₂ of the N₂ message segments, where N₂ and M₂ are positive integers and N₂>M₂≧1; and causing transmission of at least M₂ of the N₂ message segments toward the receiver for reassembly of the at least one message segment prior to reassembly of the file.

26. The method of claim 25 further comprising the steps of causing reassembly of the at least one message segment; and causing transmission of the at least one reassembled message segment toward the receiver.

27. The method of claim 25 further comprising the steps of receiving, by the receiver, the at least M₂ message segments; and reassembling the at least one message segment.
